(19) United States
(12) Patent Application Publication
(10) Pub. No.: US 2016/0061596 A1
(43) Pub. Date: Mar. 3, 2016

(54) Portable Optical Profilometer Device, System and Method

(71) Applicant: Commonwealth Center for Advanced Manufacturing, Disputanta, VA (US)

(72) Inventors: William Lyon Suhring, Suffolk, VA (US); James Michael Fitz-Gerald, Schuyler, VA (US); Robert Klein, Charlottesville, VA (US); Sean R. Agnew, Charlottesville, VA (US); Scott T. Acton, Charlottesville, VA (US)

(21) Appl. No.: 14/835,387

(22) Filed: Aug. 25, 2015

Related U.S. Application Data
(60) Provisional application No. 62/041,735, filed on Aug. 26, 2014.

(51) Int. Cl. G01B 11/30; G02F 1/19; G02B 7/08

(52) U.S. Cl. CPC G01B 11/303; G02B 7/08; G02F 1/19

(57) ABSTRACT

A hand-portable optical surface profilometer device can employ depth from defocus techniques to measure surface roughness in wide-area industrial processes.

### FIELD OF THE INVENTION

The present disclosure pertains to surface profilometers, and more particularly to a portable optical surface profilometer device, system and method.

### BACKGROUND

Surface roughness is considered to be the statistical measure of a surface's deviation from a perfectly flat plane. While all surface roughness measures go back to this definition, the exact value of the measure can vary heavily based upon the methodology used to calculate it. The direct calculation of all surface roughness measures requires the use of a height map of the sample surface. Height maps of any particular sample can be gathered through the use of a profilometer tool.

The most common numerical measure of roughness is Rₐ, and it is defined as the average value of the deviation from a linear profile along the sample surface. A similar approach to calculate a roughness value is the Sₐ statistic, which is defined as the average value of the deviation from a flat plane along the sample surface. Other roughness statistics known in the art may also be computed. While roughness statistics most often directly use the height deviation from a perfectly flat sample, there exist other calculations which focus more on the geometric features of the sample. Roughness factor is calculated as the area of the actual sample surface divided by the area of the perfectly flat sample surface.

Many advanced manufacturing processes require the operator to know the surface roughness statistics of the final product, the manufacturing equipment, or both. The success of the plastic injection molding process, for example, can depend on the quality of mold surfaces that come out of the Computer Numerical Control (CNC) milling process. Surface quality of the mold surfaces is generally characterized in terms of a low surface roughness. It has also been demonstrated that surface roughness heavily affects the results of the alumina coating process used extensively in the gas turbine industry. Surface roughness affects these two processes, and many more, due to the effects that roughness has on many physical characteristics of solids such as, but not limited to: wetting, adhesion, contact mechanics, and friction.

There exists a need for a profilometer capable of gathering roughness statistics in industrial and other field environments (i.e. non-laboratory environments). Various types of profilometer tools are available on the market. The most commonly employed type of profilometer is the stylus profilometer. The stylus profilometer measures the surface of a sample by running a mechanical tip along the surface. The vertical displacement of this tip is converted into an electric signal which corresponds to some specific height value. Despite the fact that this stylus profilometer is easy to use, it has several distinct disadvantages. The first disadvantage is the directional dependence of the device, as it only measures profile along a single direction. This can lead to an improper skew of the data when looking for results that are representative of the entire surface. Another disadvantage of the stylus profilometer is that, during measurements, the movement of the stylus along the sample surface can cause damage to the sample surface. Not only is sample damage generally unacceptable, especially for industrial processes, but the damage itself reflects poorly on the accuracy of the measurements. Due to the slow nature of taking stylus profilometer measurements, this technique would not work well for in-process measurements.

Optical techniques to measure topographical features of a sample surface offer many advantages over mechanical measures of a sample surface. An optical technique does not involve contact between the instrument and the sample surface, which reduces the chance of sample damage. Optical techniques also possess the ability to gather areal data. Therefore, using an optical technique, one can eliminate the directional dependence of the data gathered from a mechanical profilometry tool.

In various embodiments, the present disclosure considers a specifically developed focus metric, one which gives a qualitative assessment of roughness so that two images of the same subject can be compared to see which one was more in-focus. The focus metric is further a semi-quantitative measure of focus with some resilience to a given image subject. Aspects of the present disclosure also limit the computational time necessary to build the composite image in order to make the device suitable for in situ work.

In some embodiments, the device and methods in the present disclosure use a focus metric that applies a Laplacian filter, for example, and then quantifies the effect of the filter rather than quantifying the resulting filtered image itself. The effect of the filter may be quantified by taking the absolute difference between the original and unfiltered image at every point, and then dividing all of these differences by the value of the original image at each particular location. These fractional measures of change may then be converted into percentages to generate more comfortable values to work with, and then the percentages are averaged. The average percent change of each point in the filtered image is an example of the focus metric employed herein.

Due to the fact that this filtering process has a larger effect upon an in-focus image than an out-of-focus image, the focus metric increases with increasing focus in an area. The focus metric employed in embodiments disclosed herein can also use the unsharp masking method to filter the image, which sharpens in-focus images more than out-of-focus images. This focus metric obtains its resilience against an image subject due to the fact that it measures the change against the original image. Other focus metrics, by using the results of the shift rather than the shift itself, provide far less robust metrics.

In some embodiments of the present disclosure, the focus metric may be calculated over an image patch, as opposed to over a single pixel. While pixel-based focus can be established, such a process is often too computationally intensive given the goal of making the presently disclosed device and related methods suitable for in situ work.

### Depth from Defocus

Depth from defocus (DfD) is a method that involves taking a series of optical images of a sample surface from varying heights, and then stitching together the in-focus regions of these images to generate a composite image and height map. This method creates an artificial, but high, depth-of-focus for the composite image, meaning that the composite image appears to be acceptably in-focus in all regions. By knowing which image in a given series is the most in-focus and at what vertical position that image was located, one can generate a height map to correspond with the composite image. Microscope manufacturers have employed certain similar techniques in some limited applications, but none as part of a portable device (e.g., handheld) configured for in situ work in a wide range of environments and operating orientation angles, as disclosed herein. As used herein, “handheld” can mean that which can be conveniently placed and moved with only one hand, and can be considered portable.

The profilometer device disclosed in some embodiments herein operates on the DfD principal, stitching together multiple, largely unfocused images into one, entirely focused image. Using these same images, it is capable of returning roughness statistics (e.g., Rₐ, R_{z}, Sₐ, etc.) from a surface. In various embodiments, the device is completely portable, making it viable for in situ use.

### SUMMARY

In some embodiments, a portable optical surface profilometer device is provided that includes a mechanism for capturing at least one image comprising an objective lens, wherein the objective lens has a focal plane that is movable along a z-axis substantially perpendicular to a surface to be measured. The device may also include a mechanism for incrementally moving the focal plane of the objective lens along the z-axis, a communications interface for receiving commands for movement of the focal plane of the objective lens and the at least one image captured by the image capturing mechanism, a power supply, and a housing with a handle. In some embodiments, the image capturing mechanism may include a charge coupled device. The profilometer device may also include a light for illuminating the surface to be measured. Such a light may, in some embodiments, include a ring light that is coupled to the objective lens.

The mechanism for incrementally moving the focal plane of the objective lens may take one of at least two forms. In some embodiments, the mechanism may include a motor, a motor controller, a driver, an actuator coupled to the motor and objective lens for moving the objective lens along the z-axis, and an encoder for determining incremental movements of the objective lens along the z-axis. Such embodiments may also include a spine, wherein the image capturing mechanism, the objective lens, the motor, the motor controller, the driver, and the encoder are coupled to the spine and are enclosed substantially within the housing. The focal plane may be movable over a range of at least 10 mm.

In certain other embodiments, the mechanism for incrementally moving the focal plane of the objective lens may include an adaptive lens for varying the position of the focal plane along the z-axis relative to a voltage applied to the adaptive lens. These embodiments may similarly include a spine, wherein the image capturing mechanism, the objective lens, and the adaptive lens are coupled to the spine and are enclosed substantially within the housing. The adaptive lens may have a curvature range for moving the focal plane of the objective lens over a range of at least 10 mm.

The communications interface of the device may be configured to communicate with a computer. The computer may provide commands for movement of the focal plane of the objective lens, and the at least one image captured by the image capturing mechanism may be processed by the computer to calculate one or more roughness statistics. The computer may be internal or external to the housing. The device may also include a user interface and/or display for receiving commands from a user and/or presenting information to a user.

Other features of the device may include the ability of the image capturing mechanism and mechanism for incrementally moving the focal plane of the objective lens to operate at any orientation angle. The housing may also include features allowing for use of the device in a wide range of temperature, humidity, and other environmentally diverse conditions. Accordingly, the presently disclosed profilometer is readily field deployable for use outside the confines of a laboratory.

In certain other embodiments, the present disclosure is directed to a method of optically measuring topographical features of a sample surface for computing one or more roughness statistics of the sample surface. The method may include the steps of providing a portable optical surface profilometer device that includes a mechanism for capturing at least one image having an objective lens wherein the objective lens has a focal plane that is movable along a z-axis substantially perpendicular to a surface to be measured, a mechanism for incrementally moving the focal plane of the objective lens along the z-axis, and a communications interface for receiving commands for movement of the focal plane of the objective lens, and the at least one image captured by the image capturing mechanism. Next, a series of images of a region of the sample surface may be captured at incremental distances along the z-axis, and a height may be recorded at which each image is taken. The images may then be divided into a grid of substantially equally sized patches, wherein each patch is associated with a grid location in an XY-plane, the XY-plane being substantially parallel to the sample surface. The patches associated with each grid location in the XY-plane may then be stacked according to height. A focus metric may then be calculated for each patch to determine which patch in each stack is most in focus. A height map may then be generated of the imaged region based on the height associated with the most in focus patch in each stack. The height map may then be used to calculate a roughness statistic for the sample. The roughness statistic may include one or more of Rₐ, Sₐ, R_{RMS}, Rz, and R_{q}.

The focus metric may be one or more of a Laplacian filter or unsharp masking method that is applied to each patch to quantify the effect of the filter and/or masking method on each patch to determine relative focus.

In some embodiments, where the mechanism for incrementally moving the focal plane of the objective lens includes an adaptive lens for varying the position of the focal plane along the z-axis relative to a voltage applied to the adaptive lens, an additional step of performing a digital zoom on the series of images to compensate for magnification effects of the adaptive lens, and subsequently cropping out any parts of the images that do not have a correlating section in all other images in the stack, may be performed.

### BRIEF DESCRIPTION OF THE DRAWINGS

FIGS. 1-2 are exemplary sample images of a sample surface divided into four quadrants or patches, with different degrees of focus in each sample image.

FIG. 3 is a composite image of the image in FIG. 1 and the image in FIG. 2.

FIG. 4 is an illustrative wavelength image showing quantum efficiency of a compact and lightweight industrial camera.

FIG. 5 is an illustrative schematic of some embodiments of the presently disclosed profilometer.

FIG. 6 shows an exemplary power supply circuit for use in connection with some embodiments of the presently disclosed profilometer.

FIG. 7A is a cutaway view and FIG. 7B is an encased view, respectively, of an exemplary embodiment of the presently disclosed profilometer.

FIG. 8 is a schematic diagram of the interaction of the various components of certain embodiments of the presently disclosed profilometer, including a power supply.

FIG. 9 is an illustrative diagram of an embodiment of the presently disclosed profilometer employing liquid lens technology.

### DETAILED DESCRIPTION

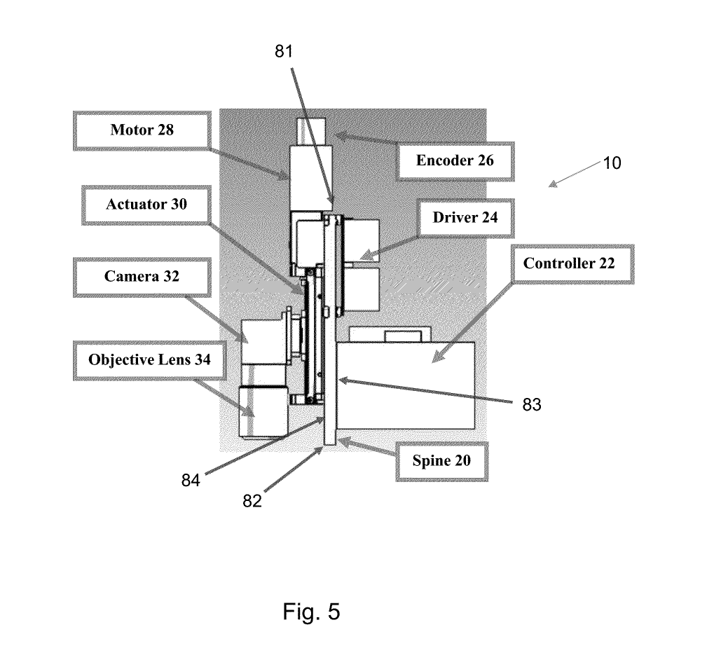

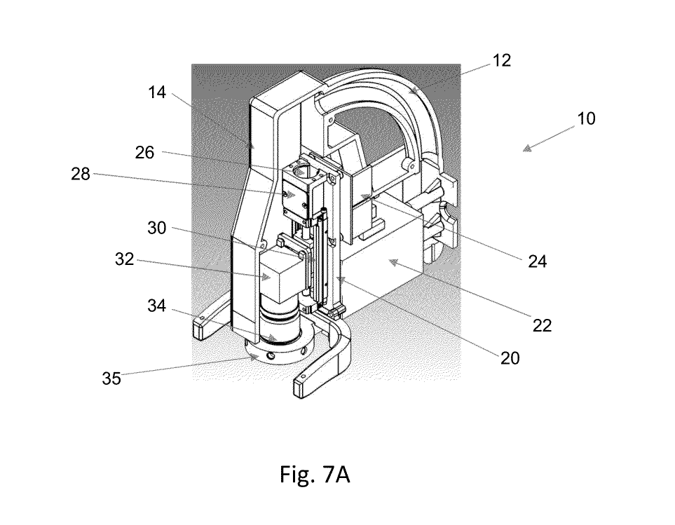

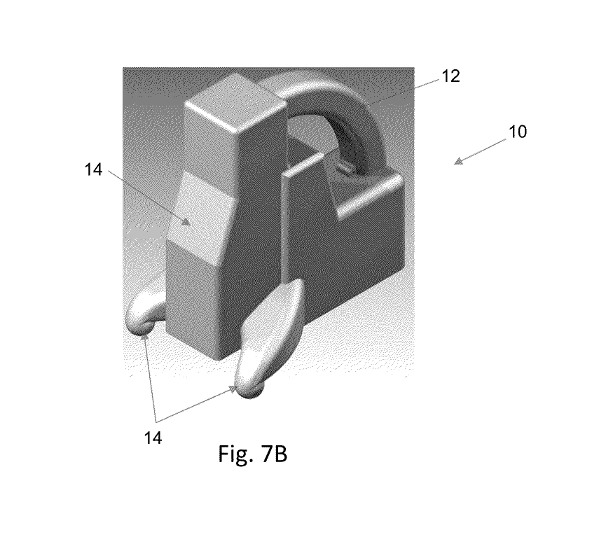

As shown in the exemplary embodiment of FIGS. 5 and 7A-7B, a profilometer 10 is provided having a handle portion 12 and a body portion 14. The body portion 14 may comprise a spine 20, to which various hardware elements are secured, including a controller 22, a driver 24, an encoder 26, a motor 28, an actuator 30, an image capturing mechanism or camera 32, and an objective lens 34.

Referring now to FIG. 5 and FIGS. 7A and 7B, in some embodiments, the spine 20 includes a top portion 81 and a bottom portion 82, and the controller 22 may be mounted to a first side 83 of the spine 20, and the actuator 30, imaging mechanism (e.g., camera 32), and objective lens 34 may be mounted to a second side 84 of the spine 20. At or near the top portion 81 of the spine 20, the driver 24, motor 28, and encoder 26 may be mounted. As shown in FIG. 5, for example, the motor 28 and encoder 26 are mounted so as to extend beyond the height and/or the top portion 81 of the spine 20. A light 35 may be provided at or about an end of the objective lens 34 for illuminating the surface to be measured. A housing 14 having a handle 12 may also be included around the various components (e.g., spine 20, actuator 30, imaging mechanism 32, lens 34, driver 24, motor 28 and encode 26) of embodiments of the profilometer device 10 for providing environmental protection to the components housed therein. The handle 12 may also provide efficient means for a user to manipulate and/or transport the device when in use In various embodiments, the arrangement of the internal components of the device 10 and encapsulation of those components by the housing 14 facilitates the portability, environmental ruggedness and operability of the device.

In operation, the controller 22 and driver 24 may provide operational voltages to the motor 28. The motor 28 in turn acts on the actuator which moves the imaging mechanism (e.g., camera 32) and objective lens 34 along the z-axis. The encoder 26 is also coupled to the actuator such that it can determine with great precision the displacement of the objective lens 34 along the z-axis.

The proper selection and integration of linear actuators, complimentary metal-oxide-semiconductor (CMOS) cameras, and microscope objective lenses of appropriate size, weight, ability and interoperability are critical for the desired precise operation of the device as a whole. For a suitable camera or other image capturing device, one with small pixel dimensions, USB 3.0 data transfer and small size can be employed. In one embodiment, the EO USB 3.0 monochrome camera available from Edmund Optics of Barrington, New Jersey can be employed. The Edmund Optics CMOS camera has dimensions of 29 mm³ and its mass, 43 g, is quite low. Such camera also has pixel dimensions of 2.2 μm² and a sensor which is manufactured by Aptina Imaging Corporation of San Jose, Calif. Small pixel size permits use of a lower-powered magnification objective lens while still gathering a desired level of spatial resolution. Also, even with 2560×1920 pixels, the sensor area is only 5.6×4.2 mm, meaning that the camera as a whole can be kept to a small size. In various embodiments, the camera employed can be controlled by suitable software to capture up to 15 frames per second, meaning that the camera will not be the limiting factor in the speed with which images can be gathered and processed. As the camera can be provided with USB 3.0 (SuperSpeed) connectivity, various integratable features can be employed. For example, this connectivity can assist with powering and controlling the camera, actuator and light setups from one cable to a computer (e.g., laptop). Images can be transferred to the host device (e.g., laptop) for processing via the USB 3.0 or other available interface.

With regard to the linear actuator 30, it is desirable to be able to move the camera 32 in precise increments corresponding to differing focal planes. An electric linear actuator 30 provides a small size and precise, controllable, incremental movement. In some embodiments, a linear actuator 30 in the form of BG15 stage from Specialty Motions, Inc. of Corona, Calif. can be employed, as providing suitable balance between step size, unit size and the required peripherals (e.g., drivers, controllers, etc.). The BG15 stage can be used with, for example, a Nema 17 motor mount, Oriental Motor CRK-544 stepper motor with an encoder and an SCX10 controller. Of course, other comparable components may be employed instead. Exemplary functions of each component within the linear actuator system are outlined below.

The BG15 stage, for example, provides high precision construction (±1 μm positioning repeatability) and suitable travel, e.g., 75 mm. For most surfaces, a 50 μm measurement range would be sufficient, but the greater travel is useful when finding the first plane of focus. The Nema 17 motor mount is necessary in some embodiments to house the drive motor, as outlined below.

The Oriental Motor CRK-544, for example, provides a suitable degree of precision. Its 0.36° step angle provides for stage steps of just under 3 μm, allowed in part by a very finely threaded rod along which the stage travels. The encoder 26 which can be provided with the chosen motor 28 allows for up to 1000 data points per revolution. This means that the device of the present disclosure can, in some embodiments, indicate exactly where in its rotation the motor is at every instant, and by association, exactly where in its range the stage is located. Knowing exactly where the stage is at all times is critical, as the computer program can compensate for differences in step size, but not for inaccurate relative position.

The SCX controller (an exemplary controller 22) also preferably has small dimensions to allow it to be integrated into the handheld system disclosed herein rather than into a larger external box. In various embodiments, the SCX controller offers a variety of data transfer connectors (e.g., USB 2.0, RS-232 and CANopen). In some embodiments, USB 2.0 can be employed, as it offers the ability for easy interconnectivity with a laptop control unit, for example. The controller 22 can also be provided with its own software package which can be integrated into software adapted for operating the profilometer.

In some embodiments, the housing (12, 14) for the portable optical profilometer can be designed for both protection of the internal components and for user-friendliness in the field. While aluminum can be employed as the housing material, molded plastic and other materials can also be employed. In various embodiments, an aluminum U-channel extrusion can be employed as a base platform because of its easy machinability and high strength-to-weight ratio. For example, two pieces of such an extrusion can be oriented in a clamshell configuration, with necessary accommodations for fastening the components to the two parts which compose the shell. The overall dimensions may be dictated by the size of the internal components, and by the travel limitations of the linear actuator/camera/lens assembly, for example.

In operation, the hardware may acquire a series of optical images of the sample surface. This series of images is of the same general region on the sample surface, but is taken at varying heights which are recorded alongside the image, By taking the images at varying heights, different regions of the sample appear in focus for each picture. After acquiring the images, each image is broken down into a series of 100×100 pixel squares and stacked with the other 100×100 sections of the same region. Each square in a given stack is then given a focus metric based variation of the image when a sharpening filter is applied. If an image is in better focus, the sharpening filter can change it by a greater degree. Thus, a higher focus metric represents a more in-focus image. One can use this knowledge to then select the most in-focus square of each region. Because optical imaging theory dictates that depth-of-field is a limited region which corresponds to a particular range of distances between the image capture device and the imaged object, the most in-focus square of a region gives height information about that region. By using this technique, a height map of the specimen can be generated from which one can compute a variety of roughness statistics. Appropriate software instructions may be provided in one or more memories operable by one or more processors for carrying out the stated functions.

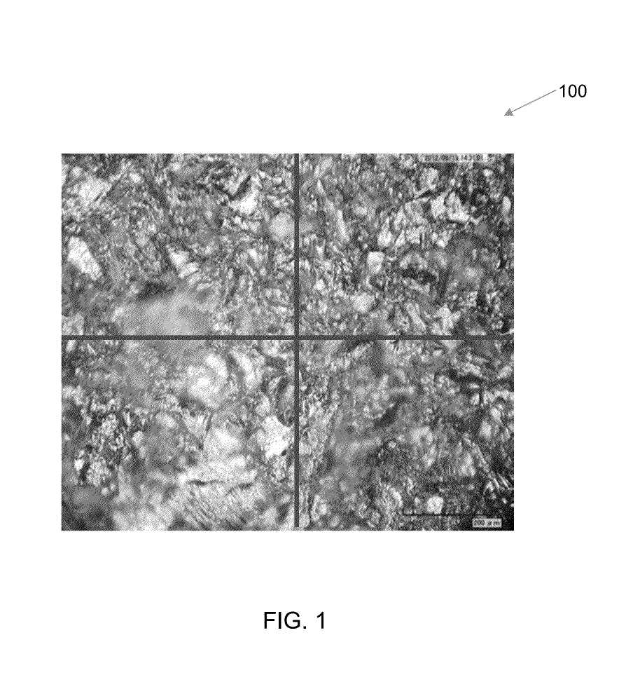

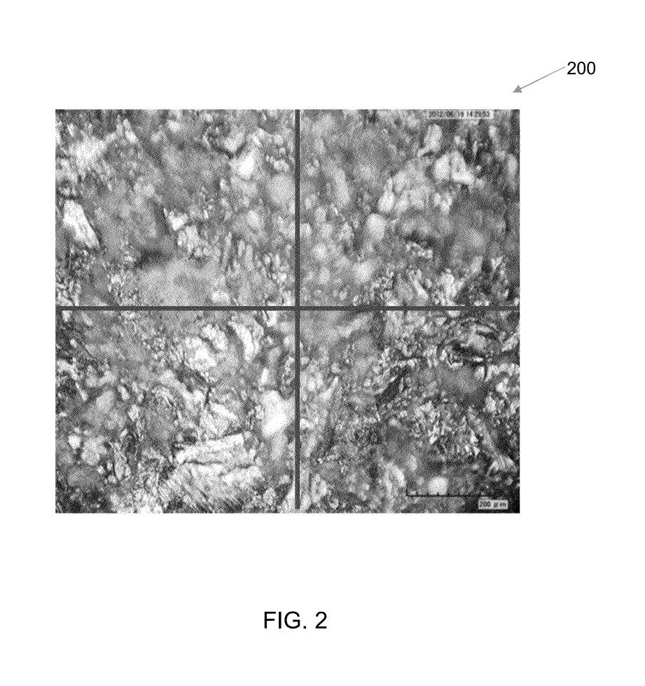

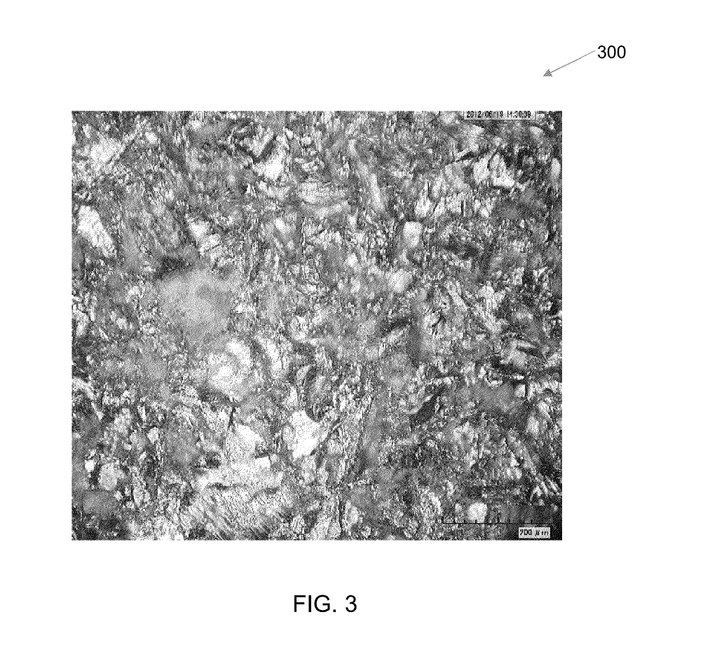

In various aspects, the DfD algorithm employed in accordance with embodiments of the present disclosure begins by taking a series of images of the same region in space and records the height value at which each image was taken. In regards to surface metrology, this region in space will be a sample surface. Consistent with the above description, all of the images are broken down into a series of separate, rectangular patches which are then stacked with the corresponding patches from the other images. A simple exemplary version of this process is illustrated in FIGS. 1-3. In FIG. 1, a first image 100 in the stack of the sample surface is shown divided into four patches. In FIG. 2, a second image 200 in the stack of the sample surface is shown, divided into four patches that correspond to the patches in the first image 100 shown in FIG. 1.

Once all of the patches have been stacked, the algorithm goes through each patch separately and finds the patch that is most in-focus of that stack, as described above. The most in-focus patch is the patch that yields the highest focus metric. Once the most in-focus patch has been selected, the software algorithm assigns that patch to the final, composite image and takes the height value associated with the image that the most in-focus patch came from and assigns that height value to a height map. The height value's position on this map and the patch's place in the final, composite image is determined by the patch's position in the XY plane in its original image. This process of finding the most in-focus patch and assigning it to the final, composite image and its height value to the final height map is repeated for every separate stack. As used herein, the “XY plane” refers to the horizontal plane which runs parallel to a perfectly flat sample surface. The “Z axis” refers to the vertical axis which runs perpendicular to a perfectly flat sample surface. Working distance is the distance along the Z axis between the focal plane and the final aperture of a given microscopy arrangement. This final aperture coincides with the end of the objective lens 34.

After the algorithm processes each individual stack, the final, composite image shows an entirely in-focus image of the sample surface. FIG. 3 shows an exemplary composite image 300 based on the exemplary images 100, 200 shown in FIG. 1 and FIG. 2. The height map should have a height value for each region of the sample surface, with the size of each region determined by the size of the patches employed. As shown in FIG. 3, the best patches from the other images are compiled here for a fully in-focus image. The top-right and top-left patches came from the first image 100 (FIG. 1) and the bottom-right and bottom-left patches came from the second image 200 (FIG. 2).

It will be appreciated that the DfD process assists in operation due, in part, to the amount of data that can be extracted from knowledge of the depth of field. Depth of field describes how far from the absolute focal plane of an optical imaging device one can move along the Z axis and still have the image appear acceptably in focus. If movements along the Z axis exceed the depth of field for a given microscopy arrangement, then the images taken at these different Z axis positions will yield different focus metrics. In various embodiments, the working distance of the arrangement remains constant throughout all Z axis positions of the camera and optics, so the only Z axis factor that changes the focus quality is the Z axis position of the camera. This relationship enables one to know the relative heights.

In various embodiments, the DfD algorithm can employ rectangular patches that are 100×100 pixels. This patch size allows for 192 separate patches to be examined over the full images gathered from the device, which are 1600×1200 pixels.

In various embodiments, the patch size can be selected as 100×100 pixels for a given initial image size of 1600×1200 pixels. Other patch sizes and shapes, such as 10×10 pixels, 20×20 pixels, and 200×200 pixels, for example, can be employed. To the extent threading of the camera is incompatible, an appropriate adapter can be employed. For example, the RMS-1″-32 adapter from ThorLabs Inc. of Newton, New Jersey can be used.

The objective lens 34 in the portable optical profilometer 10 of the present disclosure offers a shallow enough depth of focus that the software program can detect changes in focus levels while still offering a large enough field of view that a meaningful area of the surface under investigation can be inspected. Additionally, an objective lens with infinity correction can be employed, such that no additional lensing is necessary to project the desired image onto the camera sensor. Further, size and weight can be considered with regard to the objective lens, as the vertical orientation of the linear actuator meant that the force of gravity would be working against the motor. In some embodiments, the LMPLFLN50xBD from Olympus Corporation of Center Valley, PA can be employed. Its features can be found in Table 1 below.

TABLE 1
Optical characteristics of the Olympus LMPLFLN50xBD

| | Olympus LMPLFLN50xBD |
|---|---|
| Numerical Aperture | 0.50 |
| Working Distance (mm) | 10.6 |
| Focal Distance (mm) | 3.6 |
| Depth of Focus (μm) | 2.5 |
| Weight (g) | 85 |

As the linear actuator can offer a large travel range, it will be appreciated that the profilometer of the present disclosure is not limited to the use of only the above lens. Should another lens be used, differences in physical length and working distance can be adjusted for by use of the linear actuator and associated software.

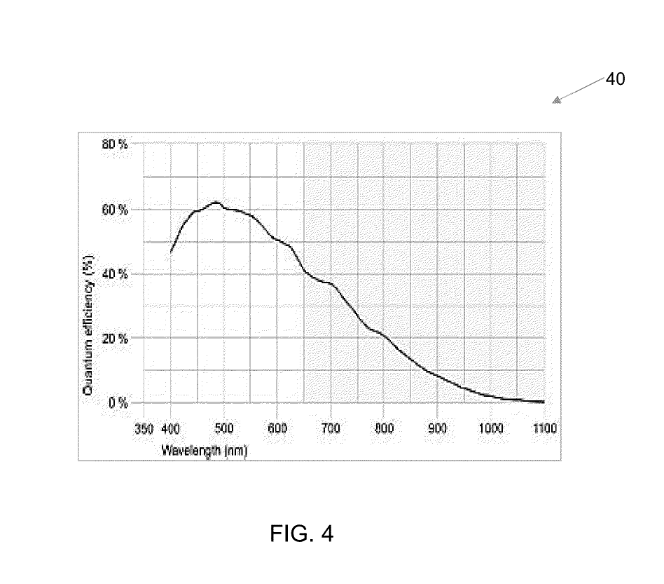

In order to provide uniform illumination on the surface under investigation, a lighting setup for the imaging system can be employed. For example, a ring light arrangement 35 (FIG. 7) can take maximum advantage of the long working distance of the objective lens, depending upon the lens employed. In various embodiments, the angle of incidence of six LEDs in the system can be, for example, 17.5° above horizontal. The wavelength of the LED (e.g., 470 nm) can be chosen based upon the characteristics of the imaging mechanism employed. A representative wavelength is shown in chart 40 shown in FIG. 4. In various embodiments, the LEDs of the ring light 35 can be wired in parallel, and connected directly to the power supply circuit. This allows the ring light 35 to not only illuminate the sample, but also to act as a visual indicator as to whether the device has been properly powered.

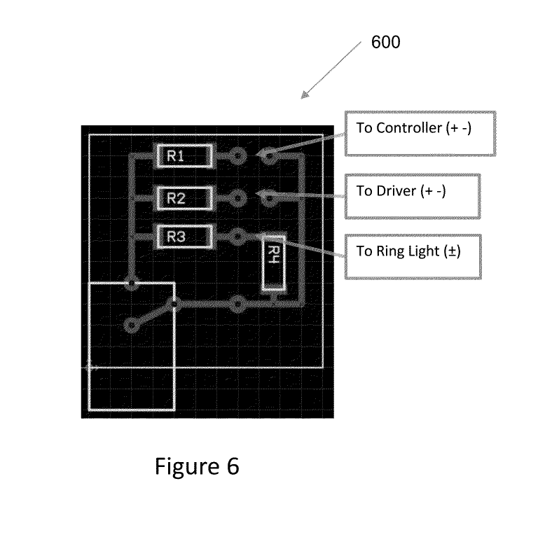

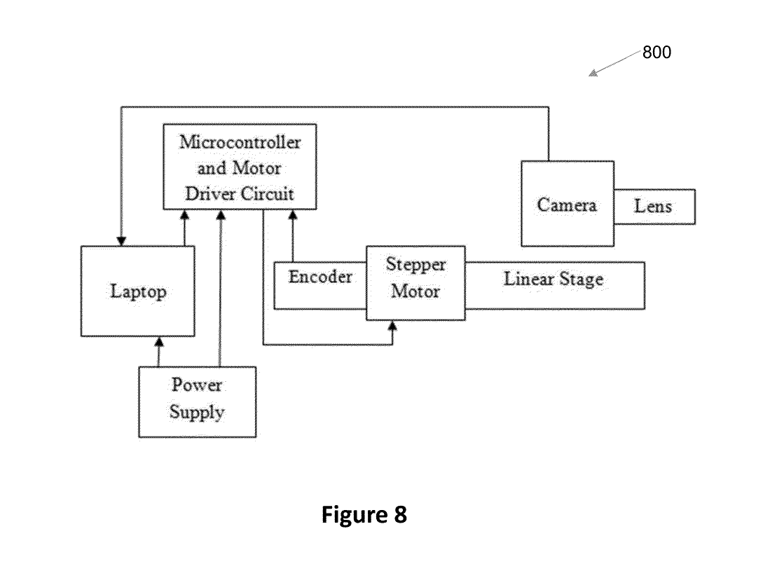

In some embodiments, the spine can be created using 3D printing technology and may include an acrylonitrile butadiene styrene (ABS) plastic material. This material is lightweight and durable. Also, a tripod foot system 44 can be employed to assist in setting the device down in appropriate position when not in use, for example. Further, a single power supply circuit can be employed to provide suitable power to the components of the device. Table 2 illustrates exemplary power requirements, and FIG. 6 illustrates a suitable exemplary power supply circuit 600 diagram. Additionally, FIG. 8 shows an exemplary schematic diagram 800 illustrating the connectivity arrangement of the power supply with various components of the device in various embodiments of the present disclosure. Once designed in software (such as with a CAD program, for example), the circuit can be transferred to a printed circuit board (PCB) by means of an etching process, and the necessary components may be soldered into place.

TABLE 2
Power requirements for various exemplary electrical components

| Component | Electrical Requirements |
|---|---|
| Controller | 24 V -- 260 mA |
| Driver | 24 V -- 700 mA |
| Ring light | 5 V -- 120 mA |
| Camera | Power over USB 2.0 (5 V - 500 mA |
| | max) |

One of several advantages of various embodiments of the profilometer in the present disclosure is its portability and ruggedness. For example, the presently disclosed profilometer is distinguishable from some existing systems, in part, because it is operable at any orientation angle, thereby providing for the measurement of roughness statistics in the field in surfaces oriented in any direction. The ability to take measurements at any orientation angle provides a distinct advantage over the prior art. Additionally, the presently disclosed profilometer includes a housing and an arrangement of component parts that allows for operation in a wide range of varying environmental conditions (e.g. wide ranges of temperature, humidity, weather related elements, etc.). Both of these characteristics make the presently disclosed profilometer readily field deployable, having the advantage of operating outside the limitations imposed by a laboratory, for example.

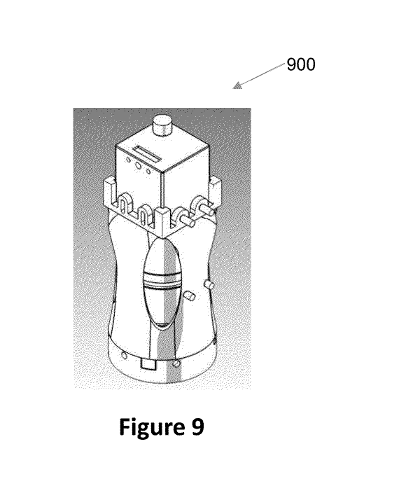

It will be appreciated by those skilled in the art that the hardware platform of the presently disclosed device can be provided in alternative arrangements to that disclosed above. For example, instead of employing a stepper motor and physically moving the camera in order to change the location of the focal plane along the Z axis, one could feasibly use liquid lens technology to move the focal plane along the Z axis. Liquid lens technology enables an adaptive lens, whose curvature can be changed by applying varying levels of voltage to the lens itself. An exemplary embodiment of such a profilometer device 900 employing liquid lens technology is shown in FIG. 9. The changes in curvature move the focal plane along the Z axis, though at the cost of modifying magnification along the way. However, changes in magnification can be corrected with additional computer algorithms, maintaining the feasibility of this proposal.

In addition, the optical profilometer of the present disclosure can be used to gather cleanliness data as well as height data. Surface cleanliness, usually judged by the presence or absence of contaminant, is a parameter of interest to many manufacturing companies. Additional computer algorithms could be constructed to analyze the stack of images and composite image in order to detect potential contaminant(s).

In employing liquid lens technology, the presently disclosed device may still employ the same focus metric described above, with DfD, but instead can use a liquid lens to mimic the effect of the stepper motor. This version of the device is also highly portable, if not more portable, than the device described above. Its design also incorporates less moving parts, which makes it even more resilient to the conditions present in in situ work and various operating angles of orientation.

Several hardware modifications can be employed with the liquid lens technology. Because of the lower power requirements in the liquid lens-enabled device, the device is able to be completely powered and controlled via a USB 3.0 interface, for example. In employing the liquid lens, the previously used motor-driven linear actuator is replaced a variable-focus liquid lens, which can be obtained commercially, for example, from Optotune AG of Switzerland. In this lens, a flexible membrane is filled with a fluid with an n-value greater than unity. A piezoelectric ring around the circumference of the membrane deflects as a voltage is applied, forcing the curvature of the membrane to change; this, in turn, changes the focal length of the lens. By placing the liquid lens in series with a 20×, infinity-corrected objective lens, for example, the system is able to focus through a height of approximately 80 μm. Changes in image magnification can be corrected through software, for example.

The imaging mechanism (e.g., camera 32) can be the same as that employed in previously described embodiments above. A darkfield illumination setup, similar to that described above, can also be employed in the liquid lens-based device, using an LED-based ring light 35, for example. Such a ring light 35 can be fabricated using a 3D printer, for example.

In order to integrate the liquid lens successfully, several modifications to the software are required. While the same image processing algorithms can be used to sort through the images, the liquid lens subtly changes magnification when moving through the various focal lengths. The software corrects for this by performing a digital zoom. After the zoom, the software crops out any parts of an image that do not have a correlating section in all of the other images of the stack. Further, control of the liquid lens is managed through the software itself. Much like with the stepper motor, the liquid lens can be controlled directly through a serial port interface due to the USB 3.0 interface.

In addition to hardware modifications to accommodate any heating issues of the assembly, the software can also account for temperature problems. The lens has commands which can make certain necessary adjustments to address certain heating concerns.

To further increase portability of the entire platform, and not just of the optical microscopy component, it will be appreciated that a smaller form-factor computer may also be employed. Due to the simple focus algorithms and liquid lens commands, the exemplary laptop based computing system discussed above could feasibly be replaced with a smaller computing system such as, for example, the Raspberry Pi or the Beagle Bone Black. These computing systems are only the size of a credit card, but still have the computing power necessary to run the required programs. In such embodiments, a user interface and/or display for communicating roughness statistics and other related information to the user may be provided. The user interface and/or display may be used in place of functions provided by, for example, an external laptop. Those having skill in the art will appreciate that the user interface and/or display may be of any convenient form or design, including for example, touch screen user interfaces, buttons, switches, LCD displays, digital numerical displays, and the like, and may be secured to the housing 14 or provided externally from the device 10.

Once data is collected as described, surface roughness analysis can proceed. There are a wide variety of roughness statistics available that can be calculated from a single profile. The average roughness, Rₐ, is the most common and a robust general measurement of the characteristic surface roughness and is used widely in industry. Other roughness statistics include the root mean squared roughness, R_{q}, which is more sensitive to outlying features and is often utilized when deep peaks or valleys are of greater concern, and the ten point height, R_{z}, which captures the average distance between the highest and lowest features of the profile. It is important to note than when using a single numerical representation of surface roughness a great deal of information can be lost, as many surfaces with widely disparate topologies can often share the same roughness value. These variations range from the shape, height, and density of features, to directional textures. Most applications envisioned for a portable, non-contact profilometer, such as control of wide area processes such as grit blasting, can be expected to impart an isotropic texture with a controlled morphology. Depending on the roughness statistics or scales desired, modifications to the lens magnification and depth from defocus algorithm (notably smaller patch sizes) may be required.

One complication associated with the use of the average roughness statistic, Rₐ, is that it relies on deviations from an expected mean value. The simplest evaluation of the mean for a 1D profile is to apply a line of best fit. This, however, introduces an undesirable sampling interval dependence on the Rₐ statistic, which is ideally invariant to the sample length. The solution to this interval size problem is the application of a weighted average instead of a line of best fit. While the exact weighting function can be altered to suit a particular situation, there is a comprehensive NIST standard protocol available that is utilized in commercially available mechanical profilometers. This protocol introduces a cutoff parameter, λ_{c}, and is the equivalent to the application of a low band pass filter to the 1D profile; allowing for the profile to be separated into a “waviness” macro-roughness profile, and a “roughness” micro-roughness profile. Following standardized protocol (ISO 4288:1996) a non-periodic profile with a Rₐ between 2 and 10 μm requires a cutoff value of 2.5 mm.

The equivalent to the 1 D profile Rₐ measurement in a 2D height profile is referred to as Sₐ. The switch in nomenclature is often ignored as these two statistics are estimators of the same surface property. Sₐ is invariant to orientation and will always capture the highest features in a region, which 1D Rₐ measurements may miss, so it does behave differently than Rₐ as a statistical quantity and deserves a separate designation. Sₐ values are often measured by fitting a plane of best fit, or a polynomial surface of best fit, to a profile due to computational simplicity. A Gaussian weighted average can be applied in two dimensions to match the 1D NIST standard methodology but computation times increase proportional to the number of height values squared, or the patch size pixel length to the fourth power. Consequentially, rigorously computing Sₐ using weighted averages on a 1600×1200 pixel profile can take a single processer several months.

In carrying out the above described inventive aspects, it will be appreciated that embodiments of the presently disclosed system may include a computer-based system, where the components can be implemented in hardware, software, firmware, or combinations thereof. Users may access the system using client computing devices, such as terminals, desktop computers, laptop computers and mobile communications devices (MCDs), for example, as described above. It will be appreciated that the presently disclosed system can incorporate necessary processing power and memory for storing data and programming that can be employed by the processor(s) to carry out the functions and communications necessary to facilitate the processes and functionalities described herein. Each client computing device may also be configured to communicate with one or more application servers. Appropriate encryption and other security methodologies can also be employed by the system, as will be understood to one of ordinary skill in the art.

Unless otherwise stated, devices or components of the present disclosure that are in communication with each other do not need to be in continuous communication with each other. Further, devices or components in communication with other devices or components can communicate directly or indirectly through one or more intermediate devices, components or other intermediaries. Further, descriptions of embodiments of the present disclosure wherein several devices and/or components are described as being in communication with one another do not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media.

Common forms of computer-readable media that may be used in the performance of the present disclosure include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, EDGE and EVDO.

Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art.

It will be apparent to one skilled in the art that any computer system that includes suitable programming means for operating in accordance with the disclosed methods also falls well within the scope of the present disclosure. Suitable programming means include any means for directing a computer system to execute the steps of the system and method of the disclosure, including for example, systems comprised of processing units and arithmetic-logic circuits coupled to computer memory, which systems have the capability of storing in computer memory, which computer memory includes electronic circuits configured to store data and program instructions, with programmed steps of the method for execution by a processing unit. Aspects of the present disclosure may be embodied in a computer program product, such as a diskette or other recording medium, for use with any suitable data processing system. The present disclosure can further run on a variety of platforms, including Microsoft Windows™, Linux™ Sun Solaris™, HP/UX™, IBM AIX™ and Java compliant platforms, for example. Appropriate hardware, software and programming for carrying out computer instructions between the different elements and components of the present disclosure are provided.

The present disclosure describes numerous embodiments, and these embodiments are presented for illustrative purposes only. These embodiments are described in sufficient detail to enable those skilled in the art to practice the disclosed device and methods, and it will be appreciated that other embodiments may be employed and that structural, logical, software, electrical and other changes may be made without departing from the scope or spirit of the present disclosure. Accordingly, those skilled in the art will recognize that the present disclosure may be practiced with various modifications and alterations. Although particular features of the present disclosure can be described with reference to one or more particular embodiments or figures that form a part of the present disclosure, and in which are shown, by way of illustration, specific embodiments of the disclosure, it will be appreciated that such features are not limited to usage in the one or more particular embodiments or figures with reference to which they are described. The present disclosure is thus neither a literal description of all embodiments of the disclosure nor a listing of features of the disclosure that must be present in all embodiments.

1. A portable optical surface profilometer device, comprising:
a mechanism for capturing at least one image comprising an objective lens, wherein the objective lens comprises a focal plane that is movable along a z-axis substantially perpendicular to a surface to be measured;
a mechanism for incrementally moving the focal plane of the objective lens along the z-axis;
a communications interface for receiving commands for (a) movement of the focal plane of the objective lens and (b) the at least one image captured by the image capturing mechanism;
a power supply; and
a housing comprising a handle.

2. The device of claim 1, wherein the mechanism for incrementally moving the focal plane of the objective lens comprises a motor, a motor controller, a driver, an actuator coupled to the motor and objective lens for moving the objective lens along the z-axis, and an encoder for determining incremental movements of the objective lens along the z-axis.

3. The device of claim 2 further comprising a spine, wherein the image capturing mechanism, the objective lens, the motor, the motor controller, the driver, and the encoder are coupled to the spine and are enclosed substantially within the housing.

4. The device of claim 2, wherein the focal plane of the objective lens is movable over a range of at least 10 mm.

5. The device of claim 1, wherein the mechanism for incrementally moving the focal plane of the objective lens comprises an adaptive lens for varying the position of the focal plane along the z-axis relative to a voltage applied to the adaptive lens.

6. The device of claim 5 further comprising a spine, wherein the image capturing mechanism, the objective lens, and the adaptive lens are coupled to the spine and are enclosed substantially within the housing.

7. The device of claim 5, wherein the adaptive lens has an adjustable lens curvature range for moving the focal plane of the objective lens over a range of at least 10 mm.

8. The device of claim 1 further comprising a light for illuminating the surface to be measured.

9. The device of claim 8, wherein the light is a ring light coupled to the objective lens.

10. The device of claim 1, wherein the communications interface is configured to communicate with a computer, and further wherein the computer provides commands for movement of the focal plane of the objective lens, and the at least one image captured by the image capturing mechanism is processed by the computer to calculate one or more roughness statistics.

11. The device of claim 10, wherein the computer is external to the housing.

12. The device of claim 10, wherein the computer is contained within the housing.

13. The device of claim 12 further comprising a user interface and a display.

14. The device of claim 1, wherein the mechanism for capturing at least one image and the mechanism for incrementally moving the focal plane are operable at any device orientation angle.

15. The device of claim 1, wherein the housing is weather-resistant such that the device may be operated in environmentally varied conditions.

16. The device of claim 1, wherein the mechanism for capturing at least one image comprises a charge coupled device.

17. A method of optically measuring topographical features of a sample surface for computing one or more roughness statistics of the sample surface, the method comprising the steps of:
providing a portable optical surface profilometer device comprising:
a mechanism for capturing at least one image comprising an objective lens, wherein the objective lens comprises a focal plane that is movable along a z-axis substantially perpendicular to a surface to be measured;
a mechanism for incrementally moving the focal plane of the objective lens along the z-axis; and
a communications interface for receiving commands for movement of the focal plane of the objective lens, and the at least one image captured by the image capturing mechanism;
capturing a series of images of a region of the sample surface at incremental distances along the z-axis, and recording a height value at which each image is taken;
dividing each image into a grid of substantially equally sized patches, wherein each patch is associated with a grid location in an XY-plane, the XY-plane being substantially parallel to the sample surface,
stacking, according to height, the patches associated with each grid location in the XY-plane;
calculating a focus metric for each patch to determine which patch in each stack is most in focus;
generating a height map of the imaged region based on the height associated with the most in focus patch in each stack;
using the height map of the imaged region to calculate a roughness statistic for the sample.

18. The method of claim 17, wherein the focus metric comprises at least one of:
a. application of a Laplacian filter to each patch and quantification of the effect of the filter on each patch to determine relative focus; and
b. application an unsharp masking method to each patch and quantification of the effect of the masking method on each patch to determine relative focus.

19. The method of claim 17,
wherein the mechanism for incrementally moving the focal plane of the objective lens comprises an adaptive lens for varying the position of the focal plane along the z-axis relative to a voltage applied to the adaptive lens;
and further comprising the step of performing a digital zoom on the series of images to compensate for magnification effects of the adaptive lens, and subsequently cropping out any parts of the images that do not have a correlating section in all other images in the stack.

20. The method of claim 17, wherein the roughness statistic calculated is one or more of Rₐ, Sₐ, R_{RMS}, Rz, and R_{q}.
